(19) United States
(12) Patent Application Publication
(10) Pub. No.: US 2026/0014658 A1
(43) Pub. Date: Jan. 15, 2026

(54) DUST MITIGATION SYSTEMS

(71) Applicant: Home Depot Product Authority, LLC, Atlanta, GA (US)

(72) Inventor: Scott L. Hager, Atlanta, GA (US)

(21) Appl. No.: 19/263,444

(22) Filed: Jul. 8, 2025

Related U.S. Application Data
(60) Provisional application No. 63/669,148, filed on Jul. 9, 2024.

(51) Int. Cl. B23Q 11/00; B04C 5/185

(52) U.S. Cl. CPC B23Q 11/0046; B04C 5/185; B23Q 11/0067

(57) ABSTRACT

A blind cutting machine can include a cutting system having a cutting blade and a member configured to automatically move in response to completion of a cutting process. The blind cutting machine can include a dust mitigation system that includes a vacuum and a separator fluidly connected with the vacuum. The separator is configured to separate debris and air drawn into an inlet of the vacuum. The dust mitigation system can include a canister fluidly connected to the separator. The canister is configured to receive the debris. A door of the canister is configured to automatically move with the member. In a first state, the door seals the canister. In a second state, the door is removed from the canister.

### CROSS-REFERENCE TO RELATED APPLICATIONS

The present disclosure claims priority to U.S. Provisional Application No. 63/669,148, entitled “DUST MITIGATION SYSTEMS” and filed on Jul. 9, 2024, the entire contents of which are hereby incorporated by reference.

### FIELD

This disclosure relates generally to dust collection. More particularly, this disclosure relates to systems and methods for emptying dust containers in a window blind and shades cutting system.

### BACKGROUND

Window blinds and shades come in a variety of different materials and sizes. The windows upon which the window blinds and shades are being installed also come in a variety of sizes. As a result, window blinds and shades can be cut to a particular width to be customized to fit a corresponding window.

### SUMMARY

In some embodiments, a blind cutting machine includes a cutting system. In some embodiments, the cutting system includes a cutting blade and a member configured to automatically move in response to completion of a cutting process. In some embodiments, the blind cutting machine includes a dust mitigation system. In some embodiments, the dust mitigation system includes a vacuum. In some embodiments, a separator is fluidly connected with the vacuum. In some embodiments, the separator is configured to separate debris and air drawn into an inlet of the vacuum. In some embodiments, a canister is fluidly connected to the separator. In some embodiments, the canister is configured to receive the debris. In some embodiments, a door of the canister is configured to automatically move with the member. In some embodiments, in a first state, the door seals the canister. In some embodiments, in a second state, the door is removed from the canister.

In some embodiments, the separator is a cyclonic separator.

In some embodiments, the dust mitigation system includes a dust shroud configured to surround at least a portion of the cutting blade. In some embodiments, the inlet of the vacuum is fluidly connected to the dust shroud to capture the debris from the cutting blade.

In some embodiments, the door forms a bottom of the canister. In some embodiments, in the second state, debris is configured to fall via gravity into a waste bin.

In some embodiments, in the second state, the member is in a home state.

In some embodiments, in response to the cutting system being in an enabled state, the vacuum is in the enabled state.

In some embodiments, in the first state, an airtight seal is formed between the door and the canister.

In some embodiments, the blind cutting machine includes a housing. In some embodiments, the cutting system is disposed within the housing. In some embodiments, the canister is disposed within the housing.

In some embodiments, a method includes enabling a cutting blade of a cutting system in a blind cutting machine. In some embodiments, in response to enabling the cutting blade, the method includes enabling a vacuum configured to receive debris generated by the cutting blade. In some embodiments, the method includes capturing debris from the cutting blade during the cutting cycle. In some embodiments, the method includes separating the debris from air being captured by the vacuum. In some embodiments, the method includes storing the debris in a canister. In some embodiments, in response to the cutting blade completing a cutting process, the method includes disabling the vacuum and automatically moving a door of the canister from a first position to a second position. In some embodiments, in the second position, the canister is opened. In some embodiments, the method includes emptying debris from the canister.

In some embodiments, in response to the cutting blade completing the cutting process, the method includes disabling the cutting blade.

In some embodiments, the method includes expelling air separated from the debris to an ambient environment.

In some embodiments, the door of the canister is disposed on a bottom of the canister and emptying debris from the canister uses gravity to empty the debris.

In some embodiments, capturing debris from the cutting blade includes drawing the debris through a dust shroud surrounding at least a portion of the cutting blade. In some embodiments, the dust shroud is fluidly connected to the vacuum.

In some embodiments, a blind cutting machine includes a cutting system. In some embodiments, the cutting system includes a cutting blade. In some embodiments, the blind cutting machine includes a dust mitigation system. In some embodiments, the dust mitigation system includes a vacuum and a separator fluidly connected with the vacuum. In some embodiments, the separator is configured to separate debris and air drawn into an inlet of the vacuum. In some embodiments, the dust mitigation system includes a canister fluidly connected to the separator. In some embodiments, the canister is configured to receive the debris. In some embodiments, the canister is fluidly connected to the separator via a conduit having a releasable connection to the canister.

In some embodiments, the releasable connection is a magnet type connection.

In some embodiments, the dust mitigation system includes a dust shroud configured to surround at least a portion of the cutting blade. In some embodiments, the inlet of the vacuum is fluidly connected to the dust shroud to capture the debris from the cutting blade.

In some embodiments, the dust mitigation system includes a base. In some embodiments, the canister is configured to be held in the base to ensure proper alignment between the canister and the conduit.

In some embodiments, the blind cutting machine includes a sensor disposed in the base and configured to indicate whether the canister is properly seated in the base.

In some embodiments, in response to the sensor indicating the canister is not properly seated in the base, the dust mitigation system is disabled.

In some embodiments, the releasable connection is a fluid tight connection.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a blind cutting machine, according to some embodiments.

FIG. 2 shows a dust mitigation system for the blind cutting machine of FIG. 1, according to some embodiments.

FIG. 3 shows a flowchart for a method of automatically emptying a dust canister, according to some embodiments.

FIG. 4 shows a dust mitigation system for the blind cutting machine of FIG. 1, according to some embodiments.

FIG. 5 shows a hose connector for the dust mitigation system of FIG. 4, according to some embodiments.

Like reference numbers represent the same or similar parts throughout.

### DETAILED DESCRIPTION

Window blinds and shades come in a variety of different materials and sizes. For example, window blinds and shades can include cellular window blinds having a plurality of honeycomb cells, faux wood blinds, or roller shades. It is to be appreciated that these are examples and cellular window blinds can have other designs. The windows upon which the window blinds and shades are being installed also come in a variety of sizes. As a result, window blinds and shades may need to be cut to a particular width to be customized to fit a corresponding window. Embodiments of this disclosure relate to a dust mitigation system such as a vacuum system for the cutting assembly of a blind cutting machine that is configured to be located within a retail store so that window blinds and shades can be customized to fit a customer's need within the store. In some embodiments, this can avoid a waiting process in which customer's otherwise order window blinds and shades online and wait for them to be cut and shipped to the customer or a retail store for pickup. More specifically, embodiments of this disclosure relate to improved dust collection features for a blind cutting machine. In some embodiments, the dust mitigation systems can simplify the dust removal process for dust and debris that are generated during the blind cutting process. It is to be appreciated that the dust removal is an important aspect to the blind cutting machines to prevent the electromechanical systems from reliability issues.

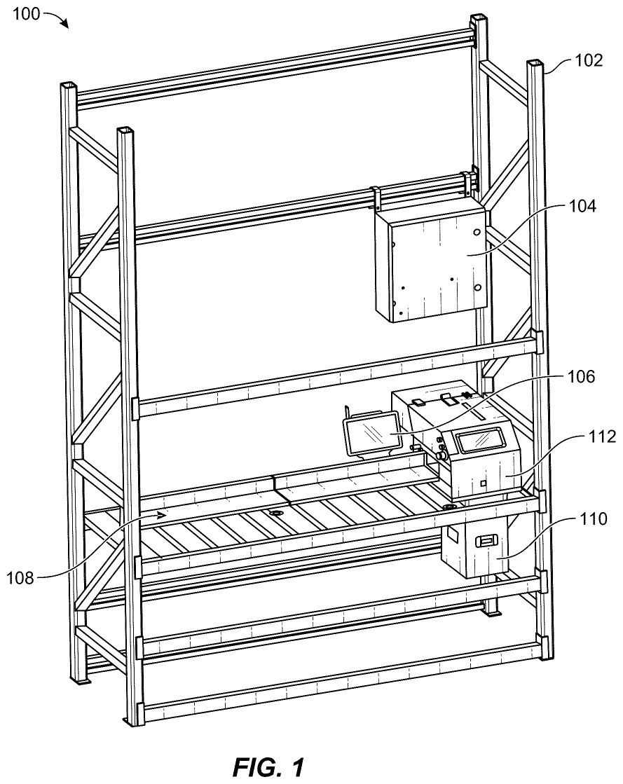

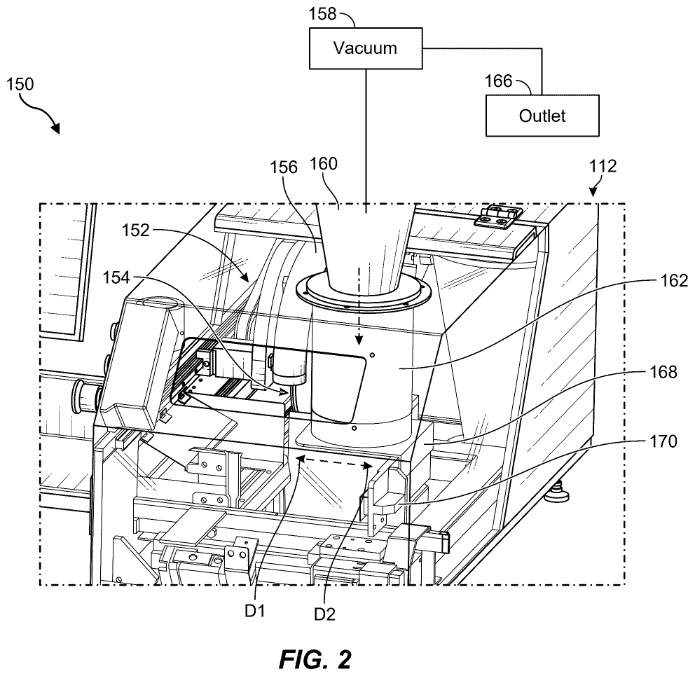

FIG. 1 shows a blind cutting machine 100, according to some embodiments. The blind cutting machine 100 can include a support structure 102. In the illustrated embodiment, the support structure 102 is a frame. It is to be appreciated that the configuration of the support structure 102 can vary beyond the illustrated embodiment. The blind cutting machine 100 includes an electronics module 104, a display screen 106, a platform 108, a cutting assembly (e.g., cutting assembly 152 in FIG. 2), and a waste bin 110. It is to be appreciated that the blind cutting machine 100 can include one or more additional components.

In some embodiments, the electronics module 104 can include various circuitry to connect the blind cutting machine 100 to a power source.

In some embodiments, the display screen 106 can provide a user interface for an operator to interact with the blind cutting machine 100 and provide for particular settings related to the blind material, width, combinations thereof, or the like.

In some embodiments, the platform 108 can receive a window blind to be cut.

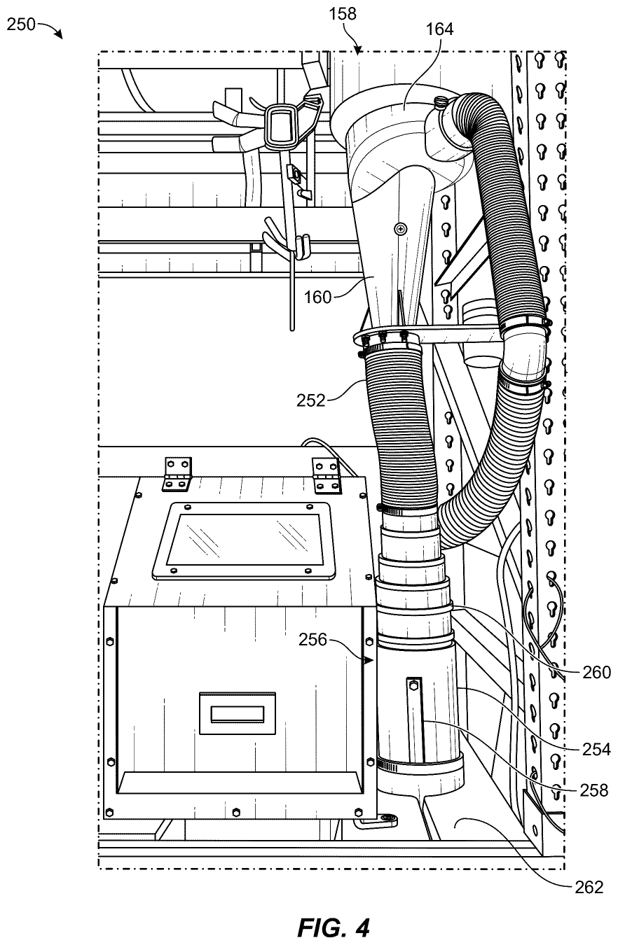

In some embodiments, the cutting assembly can include a housing 112 within which the cutting blade and other components are enclosed, protecting the operator from any interaction with the cutting blade itself. In some embodiments, the cutting assembly can include a dust shroud covering a portion of a cutting blade (e.g., shroud 156 in FIG. 2). In some embodiments, the dust shroud can be fluidly connected to a dust mitigation system (e.g., dust mitigation system 150 in FIG. 2 or dust mitigation system 250 in FIG. 4).

In some embodiments, the blind cutting machine 100 includes the waste bin 110 for collecting waste from the cutting process.

FIG. 2 shows a dust mitigation system 150 for the blind cutting machine 100 of FIG. 1, according to some embodiments. At least some features of the dust mitigation system 150 are disposed within the housing 112 of the blind cutting machine 100 (FIG. 1). FIG. 2 is representative of an internal dust containment system that includes one or more automated features for automatic emptying.

In some embodiments, the housing 112 includes a cutting assembly 152 that includes a cutting blade 154. The cutting blade 154 is partially covered by a shroud 156. It is to be appreciated that in some embodiments the shroud 156 may be optional and the cutting blade 154 is thus not partially covered by a shroud in such embodiments. The shroud 156 is configured to surround at least a portion of the cutting blade 154. The shroud 156 is connected via a hose to a vacuum 158. In some embodiments, the shroud 156 can function as an inlet to the vacuum 158. When the cutting blade 154 is enabled to perform a cut, the vacuum 158 is enabled also. In some embodiments, the vacuum 158 can be enabled prior to performing the cut. In some embodiments, the vacuum 158 can be enabled after the cutting blade 154 is enabled but before the cut is performed. In some embodiments, the vacuum 158 can be enabled prior to the cutting blade 154 being enabled. When enabled, the vacuum 158 is configured to draw air and debris through the shroud 156. In some embodiments, the debris can include dust and other chips from cutting of the window blinds and shades using the cutting blade 154. In embodiments that do not include the shroud 156, the vacuum 158 can capture air and debris from the ambient environment surrounding the cutting blade 154.

In some embodiments, the vacuum 158 is disposed vertically above the housing 112. In some embodiments, this placement can be selected so that debris separated from the air drawn by the vacuum 158 is fed via gravity into a separator 160 which is fluidly connected to a canister 162. It is to be appreciated that the vacuum 158 can be located remotely from the blind cutting machine 100. For example, in some embodiments, the vacuum 158 can be located in a separate room from the blind cutting machine 100.

In some embodiments, the vacuum 158 can include a conduit between the separator 160 and the canister 162. The separator 160 is configured to separate the debris from the air that is drawn through the vacuum 158. In some embodiments, the separator 160 can be a cyclone separator. It is to be appreciated that a cyclone separator is an example of the separator 160 and that other types of separators used in vacuums may be possible within the scope of this disclosure. The separator 160 diverts dust toward an outlet 166. The outlet 166 exhausts the air (which has had the debris removed) to the ambient environment.

In some embodiments, the canister 162 is configured to accumulate dust and debris separated by the separator 160 and received via gravity. In some embodiments, the canister 162 can be a canister without a bottom. Instead, a door 168 (e.g., a swing gate, a blast gate, or the like) can be disposed at a bottom of the canister 162. In some embodiments, the door 168 can be slightly larger than a bottom of the canister 162 so that the door 168 seals the canister 162. As a result, in a first state, the door 168 maintains a closed, airtight seal with the canister 162 so that nothing can leak from the canister 162. In some embodiments, a gasket or other sealing material can be used to create the airtight seal. In some embodiments, in a second state, the door 168 can be moved laterally so that the canister 162 is opened and dust and debris contained within the canister 162 can fall via gravity to, for example, the waste bin 110 (FIG. 1).

In some embodiments, the state of the door 168 can be controlled automatically. That is, in some embodiments, the door 168 can be moved between the first state and the second state along with a member 170. The member 170 can be automatically actuated according to the cutting process for cutting the window blind. That is, in some embodiments, the member 170 can translate laterally (e.g., in the direction of arrow D1 and D2) when the window blind is done being cut. The movement of the door 168 can be based on the movement of the member 170. In some embodiments, the movement of the door 168 can be separately actuated from the member 170. In some embodiments, an operator can manually actuate the door 168. As a result, when the cutting process finishes and the window blind is ejected from the housing 112, the member 170 can move in the direction of D1, causing the door 168 to move and releasing the contents of the canister 162. In some embodiments, the waste bin 110 can be placed vertically below the canister 162 so that the contents being emptied are compiled into the waste bin 110. An operator can empty the waste bin 110 once it fills, which can be multiple cutting cycles. In some embodiments, after the window blind is ejected from the housing 112, the member 170 moves in the direction D2 to a home state (as shown in FIG. 2), thereby closing the canister 162 with the door 168. In some embodiments, the member 170 is configured to not move until the vacuum 158 is disabled. In some embodiments, this can ensure that dust will accumulate in the canister as an airtight connection is needed for the dust to be separated and maintained in the canister 162. In the illustrated embodiment, the member 170 can be referred to as being in the home state or home position. Consequently, the door 168 covers the end of the canister 162.

In some embodiments, the state of the door 168 can be controlled automatically without use of the member 170. In such embodiments, the state of the door 168 can be controlled using a variety of different methods including, but not limited to, actuating the door 168 using, for example, a magnetic latch/door system, a solenoid, a compressed air or hydraulic system, combinations thereof, or the like. In some embodiments, the door 168 can be fixed and the canister 162 can be rotatable to empty its contents.

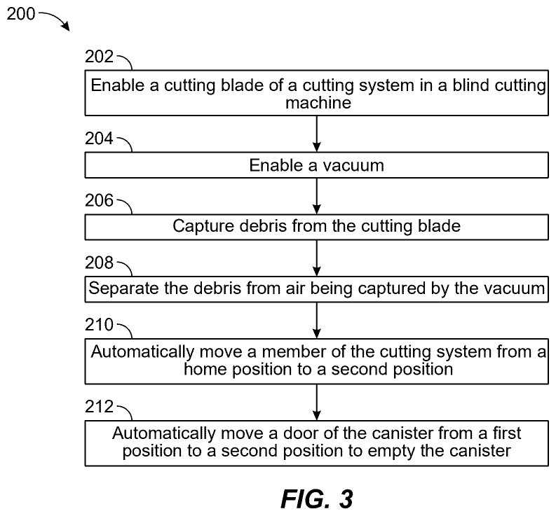

FIG. 3 shows a flowchart for a method 200 of automatically emptying a dust canister such as the canister 162 (FIG. 2), according to some embodiments.

At block 202, a cutting assembly including a cutting blade for a blind cutting machine (e.g., the blind cutting machine 100 of FIG. 1) is enabled. In some embodiments, this includes enabling a motor that causes rotation of the cutting blade.

At block 204, a vacuum (e.g., the vacuum 158 of FIG. 2) is enabled. In some embodiments, block 202 can be performed before block 204. In some embodiments, block 204 can be performed before block 202.

At block 206, the vacuum 158 draws dust and debris accumulated during a cutting process and separates the dust and debris from the air. In some embodiments, the separated air is exhausted to the ambient environment. In some embodiments, the separated air passes through a filter before being exhausted to the ambient environment.

At block 208, the separated dust and debris is retained in a canister (e.g., the canister 162 of FIG. 2).

At block 210, in response to the cutting process being completed, a member (e.g., the member 170 of FIG. 2) is automatically moved from a home position to a second position. In some embodiments, the vacuum is disabled prior to the member being moved. This can be a critical step to prevent the debris in the container from being sucked directly into the vacuum due to breaking of the airtight seal when the vacuum is enabled.

At block 212, in response to the movement of the member 170, a door (e.g., the door 168 of FIG. 2) is automatically moved from a first position to a second position. In the second position, the door 168 does not cover an end of the canister 162, and as a result, the contents of the canister 162 are emptied into a waste bin (e.g., the waste bin 110 in FIG. 1).

FIG. 4 shows a dust mitigation system 250 for the blind cutting machine 100 of FIG. 1, according to some embodiments. The dust mitigation system 250 can be an alternative to the dust mitigation system 150. FIG. 4 is representative of an external dust containment system that can be manually emptied.

Although the housing 112 in FIG. 4 does not visibly show the internal features, as in FIG. 2, the housing 112 includes the cutting assembly 152 that includes the cutting blade 154. The cutting blade 154 is partially covered by the shroud 156. The shroud 156 is configured to surround at least a portion of the cutting blade 154. The shroud 156 is connected via a hose to the vacuum 158. In some embodiments, the shroud 156 is the inlet to the vacuum 158. When the cutting blade 154 is enabled to perform a cut, the vacuum 158 is enabled also. In some embodiments, the vacuum 158 can be enabled prior to performing the cut. In some embodiments, the vacuum 158 can be enabled after the cutting blade 154 is enabled but before the cut is performed. In some embodiments, the vacuum 158 can be enabled prior to the cutting blade 154 being enabled. When enabled, the vacuum 158 is configured to draw air and debris through the shroud 156. In some embodiments, the debris can include dust and other chips from cutting of the window blinds and shades using the cutting blade 154.

In some embodiments, the vacuum 158 is disposed vertically above the housing 112. In some embodiments, this placement can be selected so that debris separated from the air drawn by the vacuum 158 is fed via gravity into a conduit 252 which is fluidly connected to a canister 254.

In some embodiments, the vacuum 158 includes a separator 160. The separator 160 is configured to separate the debris from the air that is drawn through the vacuum 158. In some embodiments, the separator 160 can be a cyclone separator. It is to be appreciated that a cyclone separator is an example of the separator 160 and that other types of separators used in vacuums may be possible within the scope of this disclosure. The separator 160 diverts dust toward an outlet 166. The outlet 166 exhausts the air (which has had the debris removed) to the ambient environment.

In some embodiments, the canister 254 is configured to accumulated dust and debris separated by the separator 160 and received via gravity through the conduit 252. In some embodiments, the canister 254 can be designed so that an operator is able to see how much dust and debris are accumulated in the canister 254. In some embodiments, the canister 254 can be, for example, transparent or the like. In some embodiments, the canister 254 can include a max fill indicator 256 and a handle 258. In some embodiments, an operator is able to see when the dust and debris accumulates to the point of reaching the max fill indicator 256 and the operator can empty the canister 254.

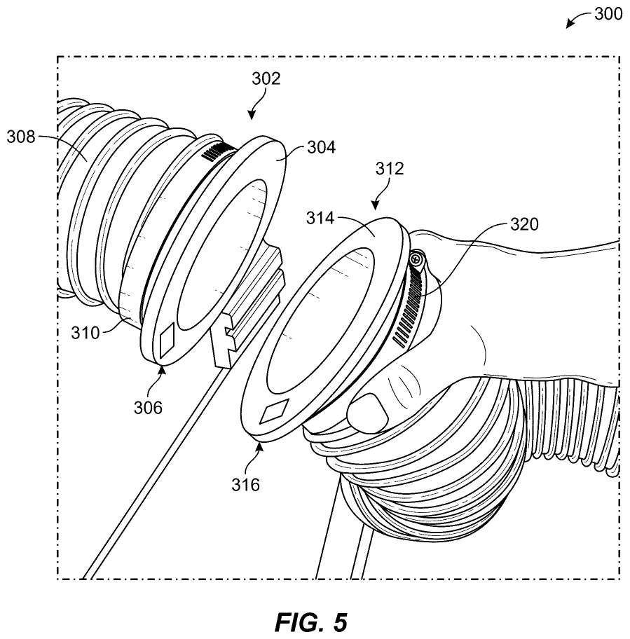

In some embodiments, the canister 254 is secured to the conduit 252 in a fluid tight connection by a connector 260. That is, in some embodiments, the conduit 252 is connected to the canister 254 in a manner that no air can be drawn into the system through the connector 260 and dust and debris are prevented from being expelled through the connector 260. In some embodiments, the connector 260 enables the conduit 252 and the canister 254 to be removably connected to each other. Various types of connections are possible for the connector 260. For example, in some embodiments, the connector 260 can be an interference fit type connector, a magnetic type connector (see FIG. 5 below), a twist on type connector, suitable combinations thereof, or the like. Other types of connectors may be possible within the scope of this disclosure that enable a fluid tight connection while enabling the canister 254 to be removable for emptying.

In practice, when the canister 254 is emptied, an operator can remove the canister 254 by releasing the canister 254 from the connector 260 and accordingly its connection to the conduit 252. After the canister 254 is emptied, the operator can reattach the canister 254 to the connector 260, thereby reestablishing the fluid tight connection with the conduit 252.

In some embodiments, the canister 254 can be disposed on a base 262. In some embodiments, the base 262 can serve as a holster for retaining the canister 254. As such, the base 262 can be sized to correspond to a size of the canister 254 being used. In some embodiments, a suction power of the vacuum 158 can be sufficiently strong that the canister 254 is elevated from the ground when the vacuum 158 is enabled. In some embodiments, it may be beneficial to include a bracket or other structure to hold the canister 254 on the ground and prevent liftoff when the vacuum 158 is enabled. The base 262 can function as an alignment guide to ensure that the canister 254 remains connected to the conduit 252 and does not inadvertently detach. In some embodiments, the base 262 can include a sensor capable of indicating whether the canister 254 is properly seated on the base 262. In such embodiments, the sensor can send a signal to the electronics module 104 (FIG. 1) of the blind cutting machine 100 (FIG. 1). In such embodiments, if the signal is interrupted, the electronics module 104 can disable the vacuum 158 or prevent the vacuum 158 from being enabled.

FIG. 5 shows a hose connector 300 for the dust mitigation system 250 of FIG. 4, according to some embodiments. In some embodiments, the hose connector 300 is a magnet type connector and can be used as the connector 260 (FIG. 4).

The hose connector 300 includes a first cylindrical member 302 having a first flange 304. A first plurality of magnets 306 are arranged about the first flange 304. In some embodiments, an outer diameter of the first cylindrical member 302 is configured to fit inside a first hose 308. In some embodiments, a first clamp 310 can be configured to fit around an outer surface of the first hose 308 at a location overlapping with the first cylindrical member 302. In some embodiments, the first clamp 310 is a hose clamp that can be tightened to ensure the first cylindrical member 302 remains within the first hose 308.

The hose connector includes a second cylindrical member 312 having a second flange 314. A second plurality of magnets 316 are arranged about the second flange 314. In some embodiments, an outer diameter of the second cylindrical member 312 is configured to fit inside a second hose 318. In some embodiments, a second clamp 320 can be configured to fit around an outer surface of the second hose 318 at a location overlapping with the second cylindrical member 312. In some embodiments, the second clamp 320 is a hose clamp that can be tightened to ensure the second cylindrical member 312 remains within the first hose 308.

In some embodiments, the first plurality of magnets 306 and the second plurality of magnets 316 are oriented so that when the first hose 308 and the second hose 318 are connected to each other, the magnets are facing so that they have opposite polarities. As a result, when the first flange 304 is disposed adjacent to the second flange 314, the first flange 304 and the second flange 314 are removably connected to each other according to a strength of the magnetic forces.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A blind cutting machine comprising:
a cutting system comprising:
a cutting blade; and
a member configured to automatically move in response to completion of a cutting process; and
a dust mitigation system comprising:
a vacuum;
a separator fluidly connected with the vacuum,
wherein the separator is configured to separate debris and air drawn into an inlet of the vacuum; and
a canister fluidly connected to the separator,
wherein the canister is configured to receive the debris;
wherein a door of the canister is configured to move with the member;
wherein in a first state, the door seals the canister;
wherein in a second state, the door is removed from the canister.

2. The blind cutting machine of claim 1, wherein the separator is a cyclonic separator.

3. The blind cutting machine of claim 1, wherein the dust mitigation system comprises a dust shroud configured to surround at least a portion of the cutting blade;
wherein the inlet of the vacuum is fluidly connected to the dust shroud to capture the debris from the cutting blade.

4. The blind cutting machine of claim 1,
wherein the door forms a bottom of the canister;
wherein in the second state, debris is configured to fall via gravity into a waste bin.

5. The blind cutting machine of claim 1, wherein in the second state, the member is in a home state.

6. The blind cutting machine of claim 1, wherein in response to the cutting system being in an enabled state, the vacuum is in the enabled state.

7. The blind cutting machine of claim 1, wherein in the first state, an airtight seal is formed between the door and the canister.

8. The blind cutting machine of claim 1, further comprising a housing;
wherein the cutting system is disposed within the housing;
wherein the canister is disposed within the housing.

9. A method comprising:
enabling a cutting blade of a cutting system in a blind cutting machine;
in response to enabling the cutting blade, enabling a vacuum configured to receive debris generated by the cutting blade;
capturing debris from the cutting blade;
separating the debris from air being captured by the vacuum;
storing the debris in a canister; and
in response to the cutting blade completing a cutting process:
disabling the vacuum;
automatically moving a door of the canister from a first position to a second position, wherein in the second position, the canister is opened; and
emptying debris from the canister.

10. The method of claim 9, wherein in response to the cutting blade completing the cutting process, disabling the cutting blade.

11. The method of claim 9, further comprising expelling air separated from the debris to an ambient environment.

12. The method of claim 9, wherein the door of the canister is disposed on a bottom of the canister and emptying debris from the canister uses gravity to empty the debris.

13. The method of claim 9, wherein capturing debris from the cutting blade comprises drawing the debris through a dust shroud surrounding at least a portion of the cutting blade, wherein the dust shroud is fluidly connected to the vacuum.

14. A blind cutting machine comprising:
a cutting system comprising:
a cutting blade; and
a dust mitigation system comprising:
a vacuum;
a separator fluidly connected with the vacuum,
wherein the separator is configured to separate debris and air drawn into an inlet of the vacuum; and
a canister fluidly connected to the separator,
wherein the canister is configured to receive the debris;
wherein the canister is fluidly connected to the separator via a conduit having a releasable connection to the canister.

15. The blind cutting machine of claim 14, wherein the releasable connection is a magnet type connection.

16. The blind cutting machine of claim 14, wherein the dust mitigation system comprises a dust shroud configured to surround at least a portion of the cutting blade;
wherein the inlet of the vacuum is fluidly connected to the dust shroud to capture the debris from the cutting blade.

17. The blind cutting machine of claim 14, wherein the dust mitigation system comprises a base, wherein the canister is configured to be held in the base to ensure proper alignment between the canister and the conduit.

18. The blind cutting machine of claim 17, further comprising a sensor disposed in the base and configured to indicate whether the canister is properly seated in the base.

19. The blind cutting machine of claim 18, wherein in response to the sensor indicating the canister is not properly seated in the base, the dust mitigation system is disabled.

20. The blind cutting machine of claim 14, wherein the releasable connection is a fluid tight connection.
